(19) United States
(12) Patent Application Publication
(10) Pub. No.: US 2013/0208724 A1
(43) Pub. Date: Aug. 15, 2013

(54) Automated Adaption to Various Industrial Ethernet Protocols

(71) Applicants: Marco Colucci, Lorrach (DE); Joachim Probst, Rheinfelden (DE); Jochen Stinus, Inzlingen (DE)

(72) Inventors: Marco Colucci, Lorrach (DE); Joachim Probst, Rheinfelden (DE); Jochen Stinus, Inzlingen (DE)

(73) Assignee: ENDRESS + HAUSER FLCWTEC AG, Reinach (CH)

(21) Appl. No.: 13/805,881

(22) PCT Filed: Jun. 20, 2011
(86) PCT No.: PCT/EP11/60185

§ 371 Date: Mar. 7, 2013

(30) Foreign Application Priority Data
Jul. 1, 2010 (DE) 10 2010 030 811.0

(51) Int. Cl. H04L 29/06

(52) U.S. Cl. CPC H04L 69/08
USPC 370/392; 370/389

(57) ABSTRACT

A method for configuring a field device that is connected to a field bus, wherein the field bus is designed for Industrial Ethernet Protocols, wherein the method comprises the following steps: analyzing a data packet transmitted on the field bus; determining an Industrial Ethernet Protocol being used in the data packet; and automatically activating a protocol stack suitable to determined Industrial Ethernet Protocol.

The invention relates to a method for configuring a field device according to the preamble of claim 1 as well as a field device for connecting to a field bus according to the preamble of claim 9.

In process automation technology, a wide variety of field devices are being used that serve for registering and/or influencing process variables. Examples of such field devices are level meters, mass flow meters, pressure meters and thermometers, etc., which register, as sensors, the process variables level, flow, pressure and temperature, respectively.

Actuators, e.g. valves or pumps, via which the flow, of a fluid in a section of pipe, and the level, in a container, can be respectively altered, serve for influencing process variables are.

In principle, all devices are designated as field devices, which are being used in a process oriented way and which process or deliver information relevant to the process.

A multitude of such field devices are proffered by the company Endress+Hauser.

Increasingly, established field bus protocols such as Profibus or Fieldbus Foundation are being replaced by Industrial Ethernet Protocols, which enable higher rates of data transmission. Admittedly, there are many various Industrial Ethernet Protocols, such as, by way of example, EtherNet/IP, Modbus TCP, EtherCAT, PROFINET or Powerlink, each of which is supported by different manufacturers. At present it is not foreseeable that one of these Industrial Ethernet Protocols can supplant the others. A supplier of field devices is therefore forced to provide, for each commercially available Industrial Ethernet Protocol, a separate version of a device, which supports said Industrial Ethernet Protocol.

The object of the invention is to enable a matching of a field device to various Industrial Ethernet Protocols.

The object is achieved through the features given in the claims 1 and 9.

Advantageous embodiments of the invention are given in the dependent claims.

A method according to the invention is designed for the purpose of configuring a field device that is connected to a field bus, wherein the field bus is designed for Industrial Ethernet Protocols. The method comprises the steps of analyzing a data packet transmitted on the field bus; determining an Industrial Ethernet Protocol being used in the data packet; and the automatic activation of a protocol stack that is suitable to the identified Industrial Ethernet Protocol.

The method according to the invention for configuring the field device enables the field device to recognize the respective Industrial Ethernet Protocol that is being used and to automatically adjust its settings accordingly by activating a protocol stack suitable to the respective Industrial Ethernet Protocol. The interaction with the present multiplicity of Industrial Ethernet derivatives to be found on the market is thereby substantially simplified. Given that the adaption of the field device to the respective protocol is automatically conducted by the field device, errors during a settings adjustment for a suitable Industrial Ethernet Protocol are avoided and the service personnel are disencumbered.

A further advantage is that all significant Industrial Ethernet Protocols can be covered through a single version of a certain field device. Because of this, it is no longer necessary to offer a protocol specific field device with a compatible software version for each Industrial Ethernet Protocol. Given that there is now only one device version and one software version, which can be used for all significant Industrial Ethernet Protocols, the distribution as well as the storage and the software updating is considerably simplified.

According to an advantageous embodiment, the type field in the Ethernet-Header of a data packet is first evaluated in order to distinguish between various Industrial Ethernet Protocols. When it becomes clear, on the basis of the type information, that the data packet is an Internet Protocol packet, then the port numbers used by the packet are evaluated. As a result of the evaluation one retains the Industrial Ethernet Protocol being used.

According to an advantageous embodiment, the Industrial Ethernet Protocol is one of the following: EtherNet/IP, Modbus TCP, EtherCAT, PROFINET, Powerlink.

According to one advantageous embodiment, as soon as the protocol that is being used on the field bus is recognized, a suitable protocol stack for this Industrial Ethernet Protocol can be compiled from various protocol stack components stored on the field device side and subsequently activated. In this, one uses the fact that several protocol layers are standardized in many prevalent Industrial Ethernet Protocols so that the required protocol stacks can be built modularly, at least to some extent, out of several recurring protocol stack components. The complexity of preparing a multitude of different protocol stacks is thereby considerably reduced.

The invention is next explained in detail with the help of the embodiments drawn in the figures.

They show:

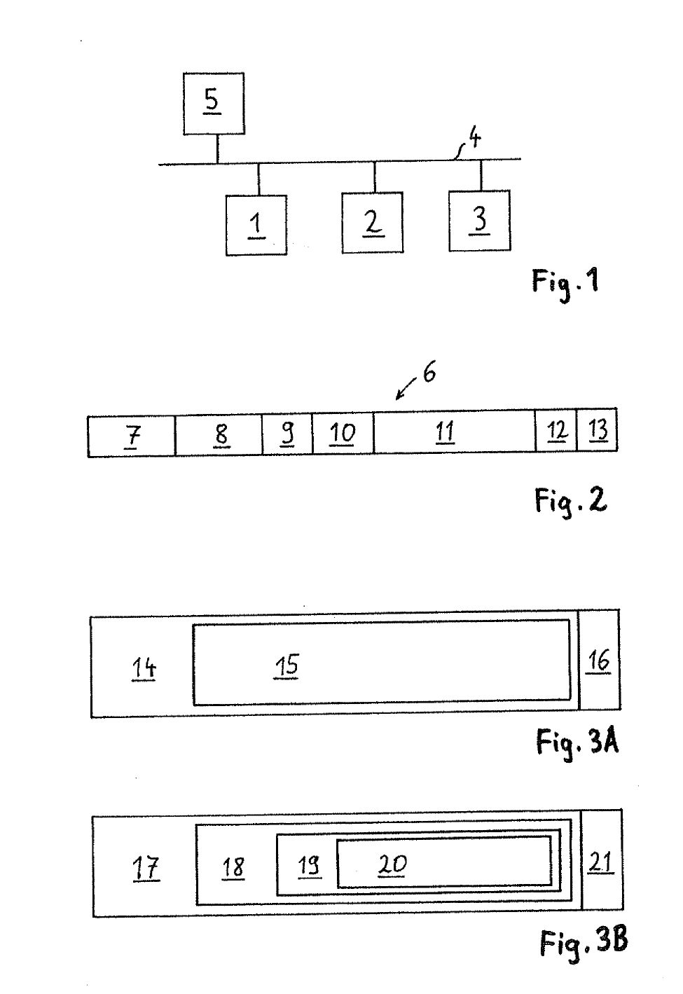

FIG. 1 an overview of a field bus system according to the invention;

FIG. 2 the data structure of an Ethernet frame;

FIG. 3A a first variation of the transmission of data of an Industrial Ethernet Protocol, wherein the data is directly transmitted via Ethernet;

FIG. 3B a second variation of the transmission of data of an Industrial Ethernet Protocol, wherein the data is transmitted via TCP/IP or UDP/IP;

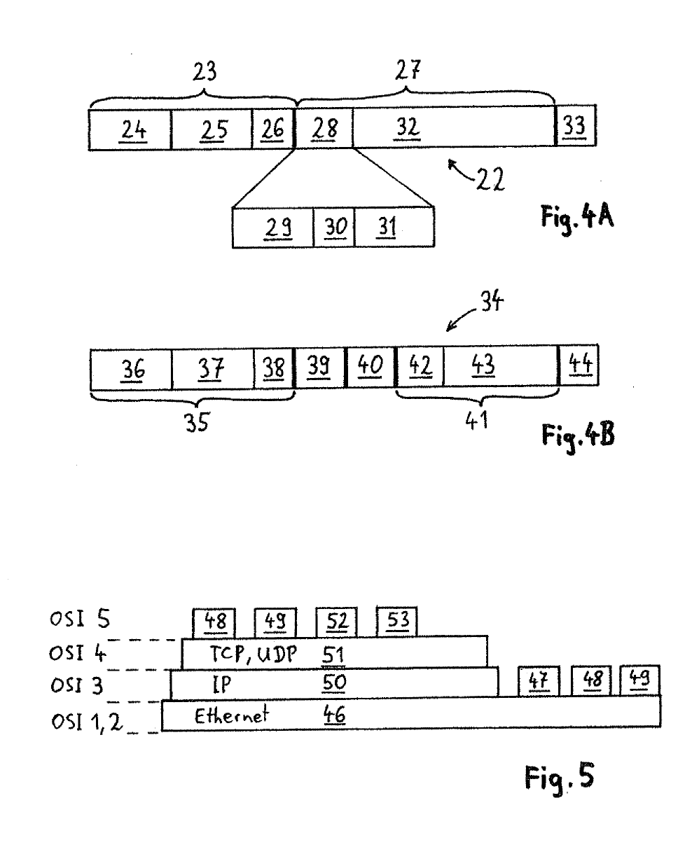

FIG. 4A a first Ethernet frame for transmitting EtherCAT data, wherein the EtherCAT data is transmitted directly via Ethernet;

FIG. 4B a second Ethernet frame for transmitting EtherCAT data, wherein the EtherCAT data is transmitted via UDP/IP;

FIG. 5 an overview of the different level of the OSI-layer model;

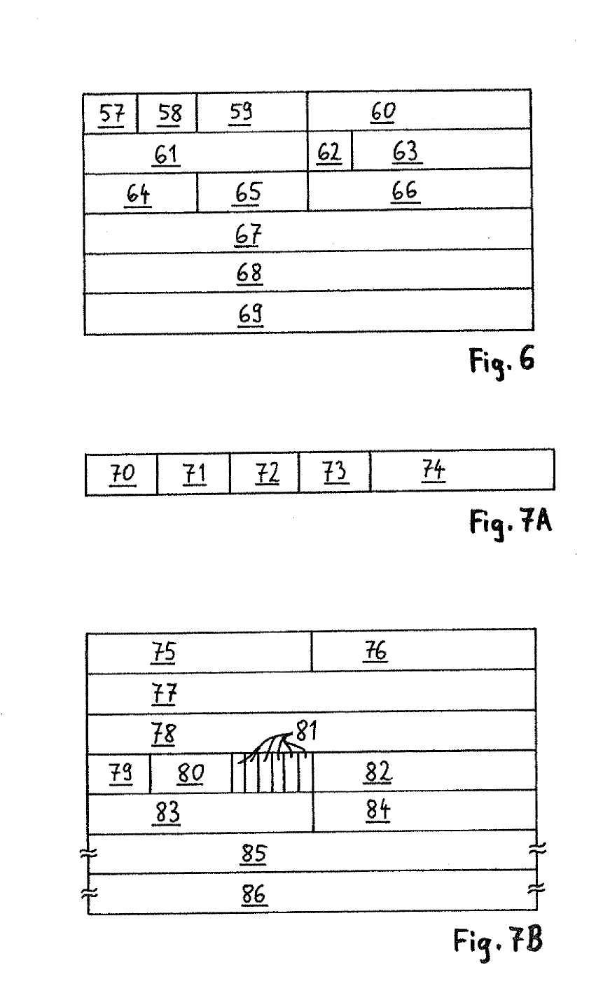

FIG. 6 the data structure of an IP-Header;

FIG. 7A the data structure of an UDP datagram;

FIG. 7B the data structure of a TCP-Header;

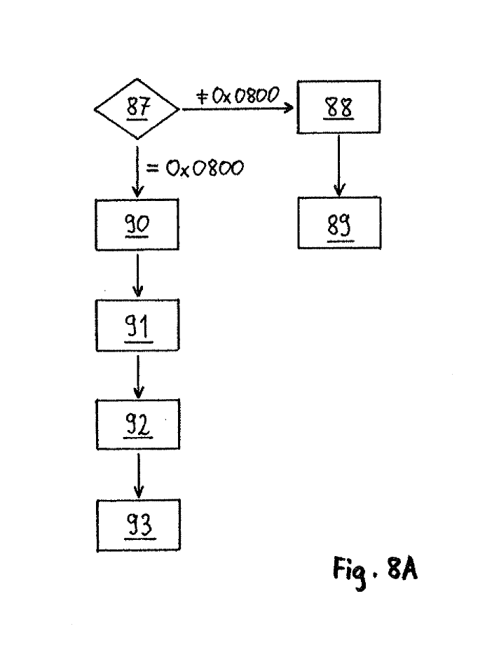

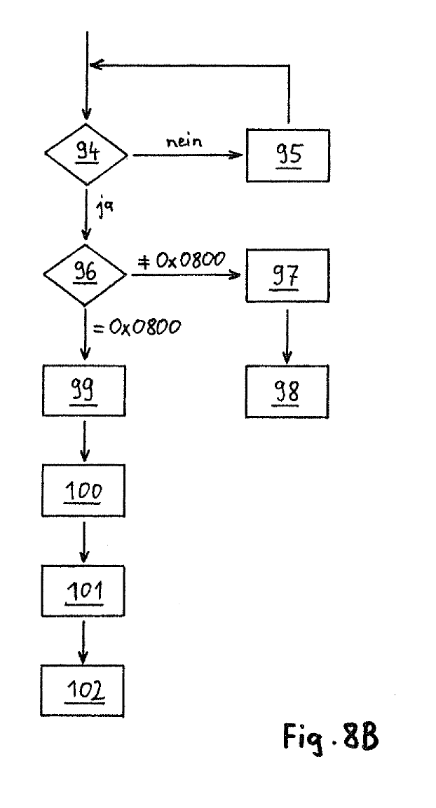

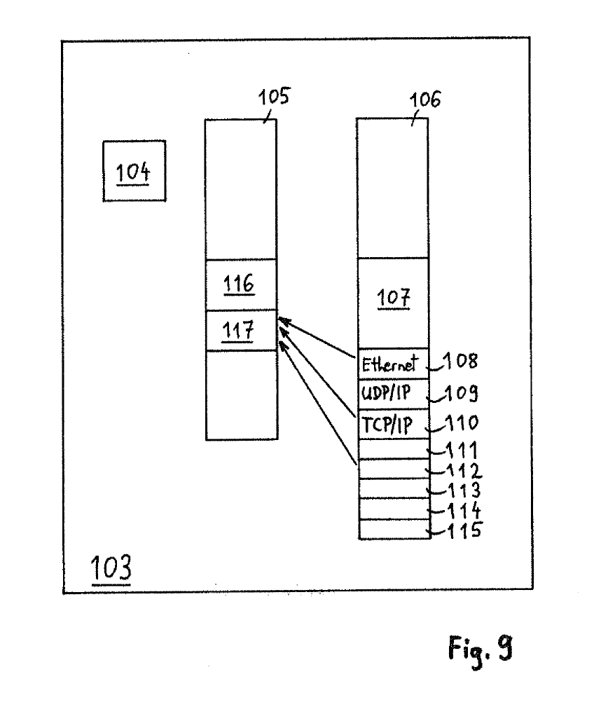

FIG. 8A, 8B application flow chart for the recognition of Industrial Ethernet Protocols according to the invention; and

FIG. 9 the configuration of a field device according to the invention.

FIG. 1 shows an overview of a field bus system with three field devices 1, 2, 3, which are connected to a host computing unit 5 via a field bus 4. The data exchange between the field devices 1, 2, 3 and the host computing device 5 occurs via a field bus protocol. Whereas up until now classical field bus protocols such as Profibus, Fieldbus (FF) or HART, by way of example, have been predominantly used in field bus systems, in modern implementations, Industrial Ethernet Protocols are increasingly being used. At the present time in the industrial sector, a multitude of different industrial Ethernet derivatives are in use, by way of example, EtherNet/IP, Modbus TCP, EtherCAT, PROFINET, Powerlink, etc. There is no indication that any one of the many Industrial Ethernet Protocols can establish itself dominantly in the marketplace.

With the present invention, a field device is made available that supports various Industrial Ethernet Protocols and that is capable of tapping into the field bus to automatically analyze the Industrial Ethernet Protocol used on the field bus and then to accordingly activate a suitable protocol stack for the relevant Industrial Ethernet Protocol.

Along with this, in the following, an overview should first of all be given of the various Industrial Ethernet Protocols.

In all industrial Internet Protocols, the data transmission on a field bus occurs with the help of Ethernet frames. The structure of an internet frame is shown in FIG. 2. This structure is stipulated in the IEEE 802.3 standard. In the header of the Ethernet frame 6, the destination MAC address 7 is specified and then subsequently the source MAC address 8 is given. MAC addresses are identifiers that are assigned to specific device hardware and enable a one to one, bijective identification of the relevant hardware. A VLAN-Tag 9, which specifies the virtual LAN (Local Area Network) with which the Ethernet frame 6 is associated, is can optionally be specified in the Ethernet-Header. If there are no different virtual LANs defined in the system, then transmitting a VLAN tag is superfluous. The type of Ethernet frame 6, the so called “Ethertype”, is given in the type field 10. By way of example, Ethernet frames wherein data is transmitted according to IP (Internet Protocol) are labeled with the Ethertype 0x0800. Subsequent to the Ethernet-Header, the actual user data 11 is transmitted. The length of the transmitted user data 11 in one Ethernet frame 6 is thereby variable; the total Ethernet frame 6 can comprise a length of between 64 bytes and 1518 bytes. Subsequent to the user data 11 a PAD filler field 12 is transmitted, followed by a CRC (cyclic redundancy check) checksum 13. The PAD filler field comprises so-called “filler bytes”, which serve to fill up the data field to a required size.

The Ethernet frame shown in FIG. 2 serves as the basic unit of all Industrial Ethernet Protocols for data transmission on the field bus.

However, there are two different basic variations for how the transmission capacity that is allocated by the Ethernet frames for the transmission of data of the respective Industrial Ethernet Protocol can be used. Both of these variations will be explained in the following with the help of FIGS. 3a and 3b.

In the first variation shown in FIG. 3a, the Ethernet-Header is transmitted first, and the data 15 of the respective Industrial Ethernet Protocol follows immediately after the Ethernet-Header 14. The data 15 of the respective Industrial Ethernet Protocol is transmitted in the user data field of the Ethernet frame. Given that the Ethernet layer forms levels 1 and 2 of the OSI (open systems interconnection) layer model, this means that the data 15 of the Industrial Ethernet Protocol is transmitted on the level 3 (network layer) of the OSI-model. The PAD- and CRC-fields 16 are transmitted at the close of the Ethernet frame.

In the first variation shown in FIG. 3a, wherein the data of the respective Industrial Ethernet Protocol is transmitted on the OSI level 3, the Industrial Ethernet Protocol “Powerlink”, by way of example, is being used.

The transmission of the data of the respective Industrial Ethernet Protocol can also occur according to the second variation shown in FIG. 3b. In this second variation, an Ethernet-Header 17 is transmitted to begin with. The data of the respective Industrial Ethernet Protocol does not follow immediately after the Ethernet-Header 17; rather, additional protocol layers are introduced. Among these, subsequent to the Ethernet-Header 17, an IP-Header 18, i.e. an Internet Protocol-Header, is transmitted, and then after this follows a TCP—(transmission control protocol) or UDP—(user datagram protocol) Header 19, each according to whether the data transmission is to occur via TCP/IP or UDP/IP. Subsequent to both of the headers 18 and 19 begins the transmission of the data 20 of the respective Industrial Ethernet Protocol. Subsequent to the Ethernet frame, the PAD and CRC fields 21 are transmitted.

The decision as to whether TCP/IP or UDP/IP should be used for data transmission depends first of all on reliability requirements of the data transmission. TCP is a connection oriented protocol, which means that a data connection between sender and receiver is set up. This enables a reliable data transmission, wherein transmission errors can be recognized and corrected. In contrast, UDP is a connectionless protocol with lower administrative costs in comparison with TCP. The network load is thereby smaller with UDP that it is with TCP, and a higher data traffic rate can be achieved. The use of TCP/IP or UDP/IP for data transmission has the advantage that common hardware components, which are also used in the infrastructure of the Internet, can be used for routing and switching data packets.

In contrast to the first variation shown in FIG. 3a, where the transmission of data to the Industrial Ethernet Protocol occurs on level 3 of the OSI layer model, in the second variation shown in FIG. 3b, level 3 of the OSI model is formed by the Internet Protocol (IP), and level 4 of the OSI model is formed by TCP or UDP. The transmission, then, of the data of the respective Industrial Ethernet Protocol first occurs on level 5 of the OSI layer model.

In the second variation of data transmission via TCP/IP or UDP/IP shown in FIG. 3b, by way of example, are used in the Industrial Ethernet Protocols EtherNet/IP and Modbus TCP. Both of these Industrial Ethernet Protocols use Internet Protocol (IP) as a basis. With EtherNet/IP, the data transmission can occur via both TCP/IP and UDP/IP. With Modbus TCP, data transmission occurs exclusively with TCP/IP.

Aside from this, there are also Industrial Ethernet Protocols, which use Ethernet frames of both the sort shown in FIG. 3a and the sort shown in FIG. 3b. These Industrial Ethernet Protocols include, by way of example, the Industrial Ethernet Protocols EtherCAT and PROFINET. With these two Industrial Ethernet Protocols, both Ethernet frames in accordance with the first variation, where the data of the respective Industrial Ethernet Protocol is transmitted directly in the user data field of the Ethernet frame, and Ethernet frames in accordance with the second variation, where the data transmission of the respective Industrial Ethernet Protocol occurs via the in-between layers TCP/IP or UDP/IP, are being used.

In the EtherCAT example, the respective Ethernet frames for both variations of data transmission are shown in FIGS. 4a and 4b. Both variations come into operation with EtherCAT. In the Ethernet frame 22 shown in FIG. 4a, the EtherCAT data is transmitted directly as user data of the Ethernet frame 22. In this respect, the Ethernet frame 22 shown in FIG. 4a is the same as the first variation shown in FIG. 3a. The Ethernet frame 22 comprises an Ethernet-Header 23, which comprises the destination MAC address 24, the source MAC address as well as the Ethertype 26. After the Ethernet-Header 23, the user data 27 is transmitted. As part of the user data 27, the EtherCAT specific Header 28 is transmitted first, which comprises the length 29, a reserve bit 30 as well as an information type 31, Finally, the actual EtherCAT commands and data 32 are is transmitted. At the end of the Ethernet frame 22, a PAD filler field and a CRC checksum 33 are transmitted.

In the Ethernet frame 22 shown in FIG. 4a, EtherCAT commands and data are transmitted directly in the user data field. In this respect, the Ethernet frame is of an Ethertype that has been specifically provided for this, namely 0x88A4. Through the value 0x88A4 in the type field 10 of the Ethernet frame (compare FIG. 2) it is clarified that EtherCAT data and commands are being transmitted in the user data field of the Ethernet frame.

The user data is also transmitted via UDP/IP in the Industrial Ethernet Protocol EtherCAT. The Ethernet frame used for this is shown in FIG. 4b. The Ethernet frame 34 comprises an Ethernet-Header 35 with a destination MAC address 36, a source MAC address 37 as well as an Ethertype 38. Subsequent to the Ethernet head 35, an IP-Header 39 as well as a UDP-Header 40 is transmitted; in this respect the Ethernet frame 34 is equivalent to the second transmission variant shown in FIG. 3b. Only after the transmission of both headers 39, 40 does the transmission of the actual user data 41 of the Industrial Ethernet Protocol EtherCAT begin. The user data comprises an EtherCAT specific Header 42, in which the length and type of the EtherCAT commands and information that follow are given, and subsequently the EtherCAT commands and data 43. At the end of the Ethernet frame 34, a PAD filler field as well as a CRC checksum 44 is transmitted.

In the Ethernet frame 34 shown in FIG. 4b, the transmission of EtherCAT commands and data occur via UDP/IP, i.e. via the Internet Protocol. In this respect, the Ethernet frame 34 is an IP packet. This is indicated by the value 0x0800 in the type field 10 of the Ethernet frame (compare FIG. 2).

In FIG. 5 an overview is once again depicted, of the levels of the OSI layer model on which the data transmission takes place in the various Industrial Ethernet Protocols. In all Industrial Ethernet Protocols, the Ethernet layer 46 serves as a basis for the data transmission. The Ethernet layer 46 forms levels 1 and 2 (the physical layer as well as the data link layer) of the OSI layer model. The Powerlink protocol 47 is stacked immediately on top of the Ethernet layer 46. This is equivalent to the transmission variant shown in FIG. 3a. In the EtherCAT protocol 48 and in the PROFINET-protocol 49, there are also frames that are transmitted immediately on top of the Ethernet layer 46. In the Powerlink Protocol 47, the data transmission occurs completely on level 3 (network layer) of the OSI layer model. In the EtherCAT protocol 48 and in the PROFINET-protocol 49, the data transmission occurs at least partially on level 3.

In an alternative to the above, an Internet Protocol layer 50 can be stacked on top of the Ethernet layer as a level 3, on top of which then a TCP or UDP layer is stacked as level 4 (transport layer). This is equivalent to the second transmission variant shown in FIG. 3b. The respective Industrial Ethernet Protocol is then transmitted on level 5 of the OSI layer model, and to be precise, via TCP/IP or via UDP/IP.

By way of example, both protocols EtherNet/IP 52 and Modbus TCP 53, as shown in FIG. 5, are transmitted on level 5 of the OSI model. In this, the protocol EtherNet/IP 52 can be transmitted both via TCP/IP and via UDP/IP. In contrast, the protocol Modbus TCP 53 is transmitted exclusively via TCP/IP.

Furthermore, the protocols PROFINET 48 and EtherCAT 49 can be transmitted not only on level 3, but also, furthermore, on level 5 of the OSI model as is visualized in FIG. 5. The protocol PROFINET 48 can be transmitted both via TCP/IP and via UDP/IP. In contrast, the protocol EtherCAT 49 is transmitted solely via UDP/IP.

A field device, according to embodiments of the present invention, is designed to evaluate the data traffic that is transmitted on the field bus and to determine the Industrial Ethernet Protocol used there. Subsequently, the field device can set its own Industrial Ethernet Protocol to be equivalent to the Industrial Ethernet Protocol being used on the field bus. For this, by way of example, the field device can activate a suitable protocol stack.

In the following, the application flow according to the invention for determining the Industrial Ethernet Protocol being used on the field bus should be depicted.

For this, the field device first accesses the Ethernet-Header of an Ethernet frame that is being transmitted on the field bus. The structure of the field device has already been depicted in FIG. 2. The Ethernet frame comprises 6 a type field 10, wherein the type of the Ethernet frame, the so-called “Ethertype” is given. This Ethertype is now analyzed by the field device. With the help of the Ethertype, it can be decided whether the Ethernet frame being transmitted on the field bus uses the Internet Protocol (IP) for data transmission, or whether some other protocol is to be stacked on top of the Ethernet layer. If the Ethernet frame uses the Internet Protocol, then this is indicated by the value 0x0800 in the type field 10 of the Ethernet-Header.

In contrast, if a value other than 0x0800 appears in the type field 10, then it is not an IP packet. In this case, it can be directly recognized which protocol is being used on the level 3 of the OSI layer model on the basis of the value stored in the type field 10. By way of example, if the value 0x88AB stands in the type field 10 of the Ethernet-Header, then the Powerlink protocol is being used on level 3, i.e. it is a Powerlink packet. In contrast, if the type field 10 has the value 0x88A4, then it is a packet with which the EtherCAT protocol is being used on level 3. In contrast, if the type field 10 has the value 0x8892, then it is a PROFINET packet with which the PROFINET protocol is being used on level 3.

In this respect, in the case where the Ethernet frame is not an IP packet, it can be determined which Industrial Ethernet Protocol is being used on the basis of the type field 10. If the value is 0x88AB then it is a Powerlink packet, and if 0x88A4, then it is an EtherCAT packet, and if the value is 0x8892 then it is a PROFINET packet.

In contrast, for the case where the Ethernet frame is an IP packet, still no assertion about the Industrial Ethernet Protocol being used can be made. In this case, the analysis of the Ethernet frame is continued. For this, the IP-Header that follows the Ethernet-Header is analyzed.

An IP-Header corresponding to the version 4 of the Internet Protocol (IPv4) is shown in FIG. 6. The meaning of the individual fields is sufficiently documented, in the protocol specification RFC791 by way of example, so that here the individual fields of the IP-Header are only summarized. The IP-Header comprises a version field 57, an IHL (IP-Header Length) field 58, a TOS (Type of Service) field 59, a Total Length field 60, an Identification field 61, various Flags 62, a Fragment Offset 63, a TTL (Time to Live) field 64, a Protocol field 65 as well as a header checksum 66. Furthermore, the header comprises a source address 67, a destination address 68 as well as additional information 69 (“Options and Padding”).

For the further analysis, the protocol field 65, which is transmitted as byte 9 of the IP-Header (wherein the byte numbering begins with byte 0) is relevant. The protocol field 65 designates the subprotocol, i.e. the protocol that follows the Internet Protocol on the next higher level, with which the user data that is transported in the IP packet is associated. If, by way of example, the IP packet contains a TCP packet, then the value 6 appears in the protocol field 65 of the IP-Header representing the TCP protocol. If, in contrast, the IP packet contains a UDP packet, then the protocol field 65 of the IP-Header contains the value 17 for the UDP protocol. These numbers are specified since RFC3232 by the IANA (Internet assigned numbers authority) in an online databank for protocol numbers. In the IP-Header of version 6 of the Internet Protocol (IPv6), there is also a field which specifies the subprotocol on the next higher level, and is the respective equivalent of the protocol field 65, except that there it is called “next header”. The valid values are the same in IP Version 6 as in IP Version 4.

By reading out and analyzing the protocol field 65 of the IP-Header, it can therefore be determined by simple means which subprotocol, UDP or TCP, follows the IP protocol on the OSI layer 4. The information as to whether UDP or TCP is being used as a subprotocol can then be used for suitably reading-out the UDP datagram or the TCP-Header, respectively. The information as to whether UDP or TCP is being used as a subprotocol can especially be used to determine the source port and destination port of the IP packet as is depicted in the following with the help of FIG. 7a and FIG. 7b. The port numbers of the source port and destination port then enable the determination of the Industrial Ethernet Protocol being used.

In FIG. 7a, the structure of a UDP datagram is depicted. The UDP datagram comprises a field 70 for the source port, wherein the port number of the sending end is given. In addition, the UDP datagram comprises a field 71 for the destination port, wherein the port number of the receiving end is given. In field 72 the length of the UDP datagram is given and in field 73 a checksum is transmitted. Subsequently, the user data 74 is transmitted.

The port numbers of the sending end and receiving end can therefore be retained by reading out the fields 70 and 71 of the UDP datagram.

As an alternative to UDP, by way of example, TCP can be used as a transmission protocol on level 4 of the OSI layer model. In FIG. 7b, the structure of a TCP-Header is shown. The TCP-Header comprises a field 75 for the source port, a field 76 for the destination port, a field 77 for the “sequence number” as well as a field 78 for the “acknowledgement number”. Furthermore, the TCP-Header comprises a field “data offset” 79, a reserve field 80, a row of flags 81, a field “window” 82, a checksum field 83, an “urgent pointer” 84 as well as an option field 85. Subsequent to the option field 85 the transmission of the user data 86 begins.

By reading out the fields 75 and 76 of the TCP-Header, the source port as well as the destination port of the IP packet can be determined. Thereby, the source port designates the port number of the sending end, while the destination port designates the port number of the receiving end. These port numbers are characteristic of the used Industrial Ethernet Protocol. An evaluation of these port numbers therefore enables a determination of the Industrial Ethernet Protocol being used in both the example shown in FIG. 7a of a UDP datagram and in the example shown in FIG. 7b of a TCP-Header. The evaluation of the port numbers retained in this way can, by way of example, occur on the basis of the following overview.

### EtherNet/I P:

### Ports:

### 2222/TCP

### 2222/UDP

### 44818/TCP

### 44818/UDP

### PROFINET:

### Ports:

### 34962/TCP (PROFINET RT Unicast)

### 34962/UDP (PROFINET RT Unicast)

### 34963/TCP (PROFINET RT Multicast)

### 34963/UDP (PROFINET RT Multicast)

### 349641TCP (PROFINET Context Manager) 34964/UDP (PROFINET Context Manager)

### EtherCAT:

### Port:

0x88A4/UDP

### Modbus TCP:

### Port:

### 502/TCP

On the basis of the above itemization it is apparent that the port numbers used are specific to the respective Industrial Ethernet Protocol being used. In the case where an IP packet is under consideration (which is indicated by the Ethertype 0x0800), it can therefore be determined which Industrial Ethernet Protocol is being used for data transmission on the field bus by evaluating the port numbers of the source port and destination port. Thereby, the allocation of the port numbers to the respective Industrial Ethernet Protocol can be carried out with the help of an allocating table, by way of example.

In summary, it can be established that through an analysis of the type field in the Ethernet-Header as well as an evaluation of the port numbers of source port and destination port, a definitive determination of the Industrial Ethernet Protocol used is rendered possible.

In FIG. 8a, the method according to the invention for automatic selection of a suitable Industrial Ethernet Protocol is depicted in the form of an application flow chart.

In step 87, the Ethertype of the Ethernet frame is evaluated on the basis of the type field 10 in the Ethernet-Header. If the Ethertype is not equal to 0x0800, then it is an Ethernet frame provided with a specifically suitable Ethertype. In this case the Ethertype permits a conclusion to be drawn as to the Industrial Ethernet Protocol being used.

If the Ethertype is not equal to 0x0800, then the Industrial Ethernet Protocol being used can be determined in step 88 on the basis of the Ethertype.

The suitable protocol stack associated with the determined Industrial Ethernet Protocol is then activated in step 89 on the field device side.

In contrast, if the Ethertype is equal to 0x0800, then the Ethernet frame is an IP packet.

In this case, the byte nr. 9 of the Ethernet-Header is read out in the next step 90, in order to determine by these means the subprotocol, i.e. the protocol that follows the Internet Protocol on the next higher level. If the value 6 appears in the byte nr. 9 of the IP-Header, then the subprotocol is TCP; if the value 17 appears there, then it is UDP.

In the step 91 following this, the respective header of the subprotocol is accessed, i.e. the TCP-Header or UDP-Header is accessed, by way of example, to determine the port numbers of the source and destination ports of the IP packet. These port numbers are specific to the Industrial Ethernet Protocol being used.

With respect to this, the Industrial Ethernet Protocol being used can be determined in the next step 92 on the basis of the port numbers. By way of example, the Industrial Ethernet Protocol associated with the port numbers can be determined by means of an allocation table.

In step 93, the protocol stack associated with the determined Industrial Ethernet Protocol is then activated on the side of the field device.

Complementing, or as an alternative to, the steps described up to this point, the transmitted user data in the data packet can also be analyzed for determining the Industrial Ethernet Protocol being used. In this analysis, the user data is examined for protocol specific structures contained therein, in particular for at least one of the following: commands, objects, services, addresses, blocks, etc., which are typical of the Industrial Ethernet Protocol being used.

In the description up to this point it has been assume that one particular Industrial Ethernet Protocol is being used on the field bus. There are, however, field bus systems in which two or more differing Industrial Ethernet Protocols are used in parallel. With this sort of “hybrid” installation, a field device according to the invention must recognize which of the differing Ethernet frames are addressed to it, then analyze the Industrial Ethernet Protocol of these Ethernet frames, and then activate a protocol stack suitable for this protocol.

In FIG. 8b, a modified application flow for this sort of “hybrid” installation is shown, wherein two or more differing Industrial Ethernet Protocols are used side by side.

With this sort of installation, the destination MAC address of the Ethernet frame is compared with the field devices own MAC address in a first step 94, in order to find out whether the Ethernet frame is addressed to the field device.

If the destination MAC address of the Ethernet frame does not comport with the field devices own MAC address, then the next Ethernet frame is waited for, in accordance with step 95.

In contrast, if the destination MAC address of the Ethernet frame does comport with the MAC address of the field device, then it is certain that the observed Ethernet frame is addressed to the field device. Only in this case is the Industrial Ethernet Protocol being used in the Ethernet frame determined.

As soon as it is certain that the observed Ethernet frame is addressed to the proper field device, the Industrial Ethernet Protocol is determined. In this the application flow is equivalent to the steps shown in FIG. 8a.

In step 96, the Ethertype of the Ethernet frame is evaluated on the basis of the type field in the Ethernet-Header.

If the Ethertype is not equal to 0x0800, then the Industrial Ethernet Protocol being used is determined in step 97 on the basis of the Ethertype. In step 98, the protocol stack for the determined Industrial Ethernet Protocol is activated on the field device side.

In contrast, if the Ethertype is equal to 0x0800, then the Ethernet frame is an IP packet. In this case, byte nr. 9 is read out in step 99 in order to determine the protocol successive to the Internet Protocol (e.g. UDP or TCP).

In the following step 100, the port numbers of the source and destination ports of the IP packet are read out. For this, the respective header of the subprotocol is accessed, i.e. the TCP-Header or UDP-Header is accessed, by way of example.

In the next step 101, the Industrial Ethernet Protocol being used is determined on the basis of the port number determined in this way.

In step 102, the matching protocol stack is activated on the field device side.

In FIG. 9 it is shown how the matching protocol stack can be compiled and activated on the field device 103 side. Preferably this can happen with the help of a building block system of various protocol stack components, which are suitably compiled.

The field device 103 comprises a processor unit 104, volatile memory 105 as well as non-volatile memory 106, e.g. flash memory. In the non-volatile memory 106, in addition to the operating software 107, various protocol stack components are also stored. In particular, in the non-volatile memory 106, an Ethernet layer 108, a UDP/IP stack 109, a TCP/IP stack 110 as well as the Industrial Ethernet Protocol layers for EtherNet/IP 111, Modbus TCP 112, EtherCAT 113, PROFINET 114, Powerlink 115 etc. are stored.

After starting up the field device, a configuration unit 116, which runs on the working memory 105, analyzes the Ethernet frames transmitted on the field bus. The configuration unit 116 thereby determines the Industrial Ethernet Protocol being used in the Ethernet frames with the help of the method shown in FIGS. 8a and 8b. A protocol stack matching the determined protocol is subsequently compiled. For this, the various required protocol stack components are loaded onto the working memory 105 from the non-volatile memory 106. The protocol stack compiled in the working memory 105 is subsequently activated.

This is to be visualized in the following on the basis of an example. Take it as a given that the configuration unit 116 determines that the Ethernet frames use the protocol Modbus TCP. In order to produce a Modbus TCP stack 117 in the working memory 105, the configuration unit 116 loads the Ethernet layer 108, the TCP/IP stack 110 as well as the protocol layer for Modbus TCP 112 out of the non-volatile memory 106. The required Modbus TCP stack 117 can be modularly compiled from these components. The Modbus TCP stack 117 compiled in this way is subsequently activated, and the field device can communicate via the Modbus TCP on the field bus.

The modular compilation of the required protocol stacks thereby offers the advantage that the storage capacity requirements for the stack components, required for the compilation of the protocol stacks for a wide variety of Industrial Ethernet Protocols, can be held within reasonable limits. Thus, it is possible to realize, with acceptable cost, a field device that can automatically adapt to a wide variety of Industrial Ethernet Protocols.

1-15. (canceled)

16. A method for configuring a field device that is connected to a field bus, wherein the field bus is designed for Industrial Ethernet Protocols, comprising the steps of:
analyzing a data packet transmitted on the field bus;
determining an Industrial Ethernet Protocol being used in the data packet; and
automatically activating a protocol stack suitable to the determined Industrial Ethernet Protocol.

17. The method according to claim 16, further comprising the step of:
communicating via the field bus according to the determined Industrial Ethernet Protocol.

18. The method according to claim 16, wherein:
the Industrial Ethernet Protocol being used in the data packet is determined by at least one of the following:
evaluating type information about the type of the data packet, which is read-out of a type field of an Ethernet-Header of the data packet; and
evaluating at least one port number of at least one port of the data packet, which is read-out from a Header of a higher protocol level of the data packet.

19. The method according to claim 16, wherein:
the Industrial Ethernet Protocol being used in the data packet is determined by:
evaluating type information about the type of the data packet, which is read-out of a type field of an Ethernet-Header of the data packet; and
evaluating at least one port number of at least one port of the data packet, which is read-out from a Header of a higher protocol level of the data packet.

20. The method according to claim 18, wherein:
determining the Industrial Ethernet Protocol being used in the data packet additionally comprises the following step:
examining the user data contained in the data packet for protocol specific data structures contained therein.

21. The method according to claims 16, wherein:
the Industrial Ethernet Protocol being used in the data packet is determined by:
evaluating type information about the type of the data packet, which is read-out of a type field of an Ethernet-Header of the data packet;
determining on the basis of the read-out type information whether or not the data packet is an Internet Protocol data packet; and
if the type information reveals that the data packet is an Internet Protocol data packet, then evaluating at least one port number of at least one port of the data packet, which is read-out from a header of a subprotocol of the Internet Protocol.

22. The method according to claim 16, wherein:
the determining of the Industrial Ethernet Protocol being used in the data packet comprises one or more of the following steps:
reading-out type information about the type of the data packet out of a type field of an Ethernet-Header of the data packet;
determining, on the basis of the read-out information, whether or not the data packet is an Internet Protocol data packet;
if the type information reveals that the data packet is not an Internet Protocol data packet, determining the Industrial Ethernet Protocol being used on the basis of the read-out type information;
if the type information reveals that the data packet is an Internet Protocol data packet;
reading-out at least one port number of at least one port of the data packet out of a header of a subprotocol of the Internet Protocol; and
determining the Industrial Ethernet Protocol being used on the basis of the at least one read-out port number.

23. The method according to claim 16, further comprising the step of:
compiling a protocol stack suitable for the determined Industrial Ethernet Protocol out of various protocol stack components and activating the protocol stack formed in this way.

24. A field device for connecting to a field bus, wherein the field bus is designed for Industrial Ethernet Protocols, comprising:
a configuration unit, that is designed to analyze a data packet transmitted on the field bus, and to determine the Industrial Ethernet Protocol being used in the data packet; and
a protocol stack automatically activated and suitable for the determined Industrial Ethernet Protocol.

25. The field device according to claim 24, wherein:
the field device is designed to communicate via the field bus according to the determined Industrial Ethernet Protocol.

26. The field device according to claim 24, wherein:
the configuration unit is designed to evaluate type information about the type of the data packet, which is read-out of a type field of an Ethernet-Header of the data packet; and
to evaluate at least one port number of at least one port of the data packet, which is read-out of a header of a higher protocol level of the data packet.

27. The field device according to claim 23, wherein:
the configuration unit is additionally designed to examine the user data contained in the data packet for protocol specific data structures contained therein.

28. The field device according to claim 24, wherein:
the configuration unit is designed to evaluate type information about the type of the data packet, which is read-out of a type field of an Ethernet-Header of the data packet, to determine, on the basis of the read-out information, whether or not the data packet is an Internet Protocol data packet; and if the type information reveals that the data packet is an Internet Protocol data packet, to evaluate at least one port number of at least one port of the data packet that is read-out of a header of a subprotocol of the Internet Protocol.

29. The field device according to claim 24, wherein:
the configuration unit is designed to load at least one protocol stack component out of a non-volatile memory into a working memory, and to stack together a protocol stack out of the loaded protocol stack components, suitable for the determined Industrial Ethernet Protocol.

30. The field device according to claim 24, wherein:
the configuration unit is designed to compile a protocol stack suitable for the determined Industrial Ethernet Protocol out of various protocol stack components and to activate the protocol stack formed in this way.
